(19) United States
(12) Patent Application Publication
(10) Pub. No.: US 2008/0280059 A1
(43) Pub. Date: Nov. 13, 2008

(54) STENCIL MASTER

(75) Inventors: JOHN CHRISTOPHER ADAMS, Scotland (GB); ANDREW MCVITIE, Scotland (GB)

Correspondence Address: FISH & RICHARDSON P.C., P.O BOX 1022, Minneapolis, MN, 55440-1022, US

(73) Assignee: G R Advanced Materials Ltd., Stirling (GB)

(21) Appl. No.: 11/932,247

(22) Filed: Oct. 31, 2007

Related U.S. Application Data
(62) Division of application No. 10/717,173, filed on Nov. 18, 2003, now abandoned.

(30) Foreign Application Priority Data
Nov. 18, 2002 (GB) 0226910.8

(51) Int. Cl. C08F 2/46; B41L 13/00

(52) U.S. Cl. 427/487; 101/127

(57) ABSTRACT

A heat-sensitive stencil master comprises a heat-sensitive polymeric film having a thickness of less than 10 μm and, coated thereon, a solid resinous foam comprising a foaming agent. The stencil master is of particular use in a digital duplicating printing process.

### FIELD OF THE INVENTION

The present invention relates to stencils and stencil masters for use in digital duplicating printing processes, and to a method for making stencils and stencil masters for such use.

### BACKGROUND TO THE INVENTION

Existing stencils for use in digital duplicators comprise a heat-sensitive film laminated to tissue paper. The tissue paper may be formed from natural fibres such as hemp, synthetic fibres, synthetic microfibres or blends thereof. The main purposes of the tissue component are (i) to provide stiffness and strength to the film during the imaging and printing processes, and (ii) to control the flow of ink through the stencil during the printing process. Whilst such stencils can provide results which are technically acceptable, the contribution of the cost of the tissue paper to the cost of the stencil can adversely effect the economies of stencil printing in relation to other processes. This is a particular problem when tissues comprising a large proportion of synthetic microfibres are required for printing high resolution images. Even at low resolution, printing by digital duplicator becomes uncompetitive against other print processes such as xerography when only a few prints are required. By achieving a lower cost construction for digital stencil masters printing by digital duplicator will become economically viable for lower numbers of copies than hitherto possible.

It has, therefore, been proposed that the tissue component of digital stencils should be replaced by a porous coating. One method of achieving this is described in GB 2306689, GB 2336916 and GB 2350691 and is based on the precipitation of a resin from a coating solution as a consequence of the change in solvent composition during the drying process. However this method has a number of disadvantages:

(1) A very precise blend of solvents is required. Manufacturing batch variations in the polymer resin, eg. in molecular weight or monomer composition, cause variations in solubility. As a consequence the coating formulation has to be adjusted for each manufacturing batch of resin.

(2) When water is one of the solvent components, variations in ambient water vapour levels causes variations in the pore forming process.

(3) Because solubilities are temperature dependent, the temperatures of the coating mix and drying process have to be precisely controlled.

(4) The resulting porous medium is not particularly cohesive and the incorporation of whisker mineral fillers is advocated as a means of reinforcing the structure. However, these minerals can act to limit the porosity of the coating to an extent that the printing properties of the resultant stencil are impaired.

5) The method relies on the use of volatile organic solvents which is undesirable because of their adverse environmental impact. In many countries use of volatile organic compounds in manufacturing processes is subject to legislation requiring the installation of expensive treatment facilities to recover or destroy effluent solvent vapour.

A second method which has been described in GB 2332868 and GB 2345912 is based on the use of coatings which are emulsions of water in a volatile organic solvent containing a dissolved resin. Through the achievement of a sequential drying process, where the volatile organic solvent is largely evaporated before the water, porous coatings are created. This method too has been found to exhibit a number of disadvantages:

(1) In practice it is difficult to select resins which achieve both a satisfactory degree of pore formation and also acceptable properties such as stiffness and coating adhesion in the resultant stencil.

(2) The sequential drying process requires expensive and technically demanding solutions in the design of the continuous web-coating machine. The drying section needs to be long and it is difficult to achieve satisfactory tension control for ultra thin films with relatively heavy coatings which are being processed under these conditions.

(3) As in the other coating process, this approach also requires use of volatile organic solvents.

It is an objective of the present invention to provide a method of manufacture of thermosensitive stencils which avoids the use of adhesive and paper, and which also avoids the afore-mentioned shortcomings. A further objective is to produce a stencil master having excellent properties in respect of handling, imaging and printing.

### SUMMARY OF THE INVENTION

According to a first aspect of the present invention, a heat-sensitive stencil master comprises a heat-sensitive polymeric film having a thickness of less than 10 μm and, coated thereon, a solid resinous foam comprising a foaming agent.

According to a second aspect of the present invention, a heat-sensitive stencil for use in a digital duplicating printing process comprises a stencil master of the type described above which has been thermally imaged to produce voids in the heat-sensitive polymeric film.

According to a third aspect of the claimed invention, a method for manufacturing a stencil master comprises coating on to a heat-sensitive polymeric film having a thickness of less than 10 μm, a liquid foam comprising a resin, or polymer, dispersed or dissolved in a volatile liquid, and a foaming agent, and drying the liquid foam to form a solid foam coating on the heat-sensitive film.

### DETAILED DESCRIPTION OF THE INVENTION

The film component of the stencil master is a heat-sensitive polymeric film of the type used in conventional thermally-imaged stencils which are film-tissue laminates. In particular, the film must be capable of perforation by a thermal printing head of the type used in a digital duplicator printing machine.

The heat-sensitive film is less than 10 μm in thickness, and typically less than 5 μm, for instance less than or equal to 3 μm, in thickness.

This film may optionally have been subjected to corona discharge treatment in order to improve the adhesion of the foam coating. Additionally or alternatively the film may be provided with a primer coating to improve adhesion of the foam coating. In this embodiment care is required in the selection of the primer material and the thickness of coating in order to ensure that it does unduly effect the imaging properties of the resultant stencil master.

The solid foam coating formed on the film is resinous, or polymeric, in nature. The resin may be any polymer which is capable of being incorporated into a volatile liquid which as a liquid foam can be dried to yield a solid foam. Typically, the resin may either be thermoplastic or cross-linked. Suitable resins include but are not restricted to polymers, co-polymers or more complex polymeric permutations of ethylene, propylene, butene, butadiene, styrene, acrylonitrile, vinyl acetate, vinyl alcohol, vinyl acetal, vinyl butyral, vinyl formal, vinyl chloride, vinylidene chloride, vinyl fluoride, vinylidene fluoride, maleic anhydride, acrylic acid, methacrylic acid, acrylic acid esters, methacrylic acid esters, vinyl methyl ether, vinyl pyrrolidone. Also suitable are resins which fall within the categories: polyester, polyamide, polyurethane, cellulose ether, cellulose ester, nitrocellulose, polyketone, rubber, alkyd, polyphenylene oxide, polycarbonate, epoxy and silicone.

Typically, for coating onto the heat-sensitive film, the resin will be dissolved in a volatile liquid or present as a resin emulsion or non-aqueous dispersion in a volatile liquid, to form a coating liquid which will form the basis for a liquid foam. In the context of the present Application, a volatile liquid is one which will evaporate from the liquid foam while on the coating machine at a temperature less than the shrink temperature of the heat-sensitive film. Typically, the volatile liquid will have a normal boiling point of at least 40° C. and at most 120° C., although liquids with higher boiling points may also prove useful provided the drying conditions are selected so as to avoid substantial shrinkage of the heat-sensitive film. Non-aqueous liquids may be used, but the preferred liquid for use in the present invention is water, for processing and environmental reasons.

The resin may be cross-linked before, during or after the coating operation, for instance by chemical reaction or by irradiation. In one specific embodiment, the resin component of the liquid foam is a water-based emulsion which is capable of being cross-linked by ultraviolet or electron beam irradiation. Such emulsions must be capable of forming a solid foam on evaporation of the water component prior to irradiation. This effect may be achieved either because it is a property of the cross-linkable resin or because the resin has been combined with other components which yield a solid foam before irradiation. Good results have been achieved by electron beam curing of emulsions based on acrylate derivatives of polyol polyurethanes. Using a dose in the range 3-5 MRad and acceleration voltages in the range 125-200 kVolts significant increases have been achieved in both the stiffness and tensile strength of the solid foam coatings.

Typically, the amount of resin solids included in the coating liquid is in the range 5-50% by weight. Lower amounts of resin may be used, but will require more time/energy to dry the coating.

The foam coating further comprises a foaming agent, or foam stabilizer; the two terms are often interchangeable in the art. Suitable foaming agents include surfactants. In the case of water-based systems, it is preferred to use a foaming agent having an HLB value of greater than 6, ie. one which favours the formation of oil-in-water emulsions.

Specific examples of suitable foaming agents include but are not limited to anionic materials such as alkyl sulphates, alkylaryl sulphates, alkylarylether carboxylates, alkylarylether sulphates, olefin sulphonates, paraffin sulphonates, phosphate esters, sarcosinates, sulphosuccinates, sulphosuccinamates, taurates, isethionates; cationic materials such as amides, amidoamines, imidazolines, quaternaries; nonionic materials such as alcohol ethoxylates, alkylphenol ethoxylates, amide ethoxylates, amine ethoxylates, alkylolamides, amine oxides; and amphoteric materials such as betaines, glycinates, imidazolines, propionates. There is no limit in the selection of the foaming agent, other than it should not impair other characteristics of the liquid foam eg. stability of the resin emulsion, or properties of the resultant solid foam, eg. foam stiffness. Favoured materials are salts of long chain fatty acids, such as ammonium stearate. Where, however, antistatic properties are desired in the solid foam coating it may be desirable to use a sulphate or sulphonate foaming agent, preferably a sulphate foaming agent, optionally in conjunction with another foaming agent, for instance a salt of a long chain fatty acid, such as ammonium stearate. Sodium lauryl sulphate is a typical sulphate foaming agent.

Typically, the amount of foaming agent included in the coating liquid is in the range 0.5-25% by weight, preferably 1-5% by weight. Higher amounts of foaming agent may be used, but have little impact on liquid foam structure.

Fibrous materials may be advantageously incorporated to improve the stiffness of the solid foam. These include but are not restricted to glass, carbon and polymer fibres such as polyester and polyvinyl alcohol. Preferably, the fibrous material comprises carbon, and more preferably it comprises at least 95% by weight carbon. For instance, the fibrous material may be provided with a sizing agent on the surface of the fibres, to enhance dispersibility in the liquid from which the liquid foam is to be formed. The sizing agent may be a resin, such as a polyurethane resin.

Choice of fibre thickness, or diameter, is based on a consideration of the size of pixel voids. The fibre thickness should be sufficiently low not to impede ink flow through these voids. However, it is desirable to have as great a fibre thickness as possible in order to maximise coating stiffness. Suitable fibres will typically have a diameter of greater than 1 μm and less than 10 μm. The fibres will typically have a length in the range 100 μm to 14 mm, preferably 100 μm to 5 mm. The use of milled fibrous material, generally having a length in the range 100 μm to 500 μm, may facilitate dispersion in the foam coating.

If fibrous material is to be included in the stencil master, the higher the amount of fibrous material the higher the tensile strength and stiffness of the stencil master. The weight ratio of fibrous material:resin solids (in the dry solid foam) may be as high as 1:1, or even higher than this. However, typically, the weight ratio of fibrous material:resin solids will be in the range 1:5 to 1:30, preferably 1:5 to 1:15. We have found that the incorporation of carbon fibres or milled carbon fibres in particular has enabled significant improvements in the tensile strength and stiffness of the solid foam. Furthermore, an antistatic effect may be achieved by adding a sufficient quantity of carbon fibres or milled carbon fibres. This antistatic effect is particularly beneficial since it derives from the electronic conductivity of the carbon (graphite), and therefore does not vary with ambient humidity unlike the antistatic properties achieved by adding, for instance, ionic conductive agents. The antistatic effect increases with higher amounts of carbon fibre or unmilled carbon fibre. Typically, however, where antistatic properties are desired the amount of carbon fibre or milled carbon fibre will be at least 1.0% by weight based upon the weight of the solid foam.

Pigments and fillers may be incorporated in the foam coating, including inorganic materials such as talc, mica, clay, silica, micronised silica gel, calcium carbonate, aluminum silicate, barytes, titanium dioxide, zinc oxide, carbon black and organic materials such as waxes and other resin particles, starch and other cellulose based derivatives.

Other functional additives may be incorporated in the foam coating, including antistatic agents, adhesion promoters (for improving coating adhesion to the heat-sensitive film base), release agents and colorants. Antistatic agents are incorporated to achieve an antistatic effect in the solid foam coating which typically will be evidenced by the achievement of a surface electrical resistance of up to 10¹³ ohms/square. Suitable adhesion promoters include aziridine derivatives and compounds of zirconium or titanium. Aziridine derivatives are particularly useful for improving coating adhesion to corona discharge treated films.

Other additives may be incorporated to improve the coating quality of the liquid foam, such as wetting agents dispersing agents and viscosity modifiers. Useful viscosity modifiers include sodium carboxymethylcellulose and cellulose ethers such as hydroxypropylcellulose.

A coating liquid is prepared by combining, in a volatile solvent, a resin, a foaming agent and any optional additives. A liquid foam is typically generated from the coating liquid by incorporation of air or other gas such as nitrogen or carbon dioxide. This process may be accomplished by stirring with a high speed stirrer. More advantageously it can be carried out by using a rotor/stator mixer which is specifically designed for this task, for example the continuous foaming equipment manufactured by Mondomix BV (Netherlands). This type of equipment enables the ratio of air to liquid to be selected and maintained throughout the foam generation process. The mixer may be located in the supply line to a coating machine, as a so called in-line mixer, to generate the liquid foam for immediate use at a rate commensurate with the coating process.

It is desirable that the stencil masters according to the present invention are able to replicate the printing characteristics of those known in the art, for example, stencils which are laminates of film and porous tissue. In particular it is desirable that the stencil masters according to the present invention do not have an excessively large pore volume in comparison with prior art stencil masters. In these circumstances there is a risk that it will require a longer time to fill these pores at the start of the printing process, with the result that it will require a large number of copies to achieve a complete printed image. In practice, this requirement to limit pore volume means that care should be taken to ensure that the solid foam coating is not excessively thick. Solid coatings with a thickness of less than 35 μm, and preferably less than 30 μm, are capable of providing complete copy quality from the first print when used with an appropriate design of digital duplicator and ink. When making thin coatings of this type, the size of bubble in the liquid foam in relation to the desired thickness of wet foam coating becomes an important consideration. The maximum possible bubble size for a given thickness of liquid foam coating will depend to some extent on the method employed to control coating thickness. As a general rule, the bubble size should not exceed the thickness of the liquid foam coating. Otherwise, the resultant coating is marred by defects caused by oversize bubbles. The nature of the defect depends on the method of coating and the means by which coating thickness is controlled. Typically a linear mark occurs in the direction of coating, representing a visible variation in the uniformity of the coating which also adversely affects the printing performance of the resultant stencil. Frequently the presence of oversize bubbles prevents complete coverage of the surface of the heat-sensitive film base. For instance, in order to achieve a defect-free solid foam at a thickness of 30 μm when using a Mayer bar to control the thickness of coating it is generally necessary to produce a liquid foam where the maximum bubble size is less than 50 μm.

There are a number of factors that control the uniformity and maximum bubble size of liquid foams. However, when it is necessary to make liquid foams of the type described above with a maximum bubble size which is significantly less than 100 μm, it is preferable to use an Aphron Generator to make the liquid foam rather than the more conventional blade stirrers or rotor/stator mixers described above. The construction of this type of equipment is described in “Foams and Biliquid Foams—Aphrons”, Felix Sebba, John Wiley & Sons, (1987) pages 64 and 65. Essentially this equipment comprises a horizontal disc which rotates on a vertical shaft between two baffle plates in the liquid to be foamed. When using this equipment, disc rotation speed is a critical parameter in controlling the size of bubbles. Because of the increase in viscosity of the liquid during the coating process, it is desirable to use a constant torque motor to drive the rotating disc.

The application of the liquid foam to the heat-sensitive film can be carried out by standard coating techniques including knife-over-roll, Mayer bar and slot-die methods. The drying process can be carried out by standard techniques, including hot air drying, which are designed to ensure that the film substrate temperature does not exceed the threshold temperature to incur shrinking.

The porous solid foam coating may be formed on one side of the heat-sensitive film or on a sub-coat (eg. an adhesion promoting sub-coat) on the surface of the heat-sensitive film.

The solid foam coating that is formed is an open-cell solid foam which permits the flow of liquids, particularly ink, such that when the stencil master has been imaged to create voids in the heat-sensitive film, liquids entering the solid foam coating can exit via the image voids in the film. Lateral connection of the cells in the solid foam is desirable to enable this component of the stencil to act as an ink reservoir and balance the supply of ink between areas where there is a large concentration of image voids and those areas where there are few or none. In order to achieve the desired degree of ink flow through the porous solid foam and to avoid pores becoming blocked by pigmented ink preferably most of the pores are greater than 5 μm in diameter, and more preferably greater than 10 μm in diameter.

Coating weight of the solid foam has some impact on the stiffness of the stencil master, some increase in stiffness being achieved at increased coating weight. However this approach increases material costs and is likely to increase the complexity and cost of the drying process as a result of the need to evaporate greater quantities of the volatile component of the liquid foam.

The density of the solid foam, which relates to pore volume, is an important parameter for the control of stiffness and printing properties. The stiffness of the foam increases as the density of the solid foam decreases. Decreasing foam density also increases ink flow. However, there is a potential disadvantage in relying on use of low foam densities to achieve a desired stiffness in that the intrinsic strength of the solid foam eg. resistance to compression can be adversely affected.

The resulting stencil master may have a thin release coating, eg. silicone resin, on the side opposite to the foam coating, to prevent the film from sticking to the thermal printing head during the imaging process and to prevent fouling of the thermal printing head through the progressive build-up of polymer melt after imaging a number of stencil masters. The release coating may also contain an anti-static agent.

The porous solid foam coating may be the sole porous component of the stencil master or other porous components may be provided on the surface of the solid foam coating opposite to the film side. This additional porous component may be a porous tissue laminated to the solid foam coating. Such tissue may be made by a wet or dry-laid process and comprise natural fibres such as hemp, cellulose, wood-pulp or the like, or alternatively synthetic fibres or microfibres composed of materials such as resin, glass or carbon, or blends of different types of fibre. The additional porous component may also take the form of a further porous coating or printed pattern comprising a thermoplastic or cross-linked resin, anti-static agent or release agent.

Stencil masters according to the present invention may be prepared having a variety of stiffnesses and/or tensile strengths. For instance, stencil masters may be prepared having a stiffness of greater than 25 mN, greater than 35 mN, and even greater than 80 mN, as measured using a Lorentzen and Wettre Stiffness Tester Model SE016 under the following conditions: sample width 38 mm, bending angle 30°, bending length 1 mm, bending speed 5°/s, temperature 22±2° C., relative humidity 65±10%. However, a more meaningful measure of the stiffness of the stencil masters takes into account the coating weight of the solid foam, and preferred stencil masters have a stiffness (mN):coating weight (g/m²) ratio of at least 6, more preferably of at least 8, and most preferably of at least 10.

While the stencil master and stencil of the present invention have been primarily described in relation to their use in digital duplicating printing processes, they also find use in screen printing processes.

According to yet another aspect of the present invention, a heat-sensitive stencil master comprises a heat-sensitive polymeric film, typically having a thickness of less than 10 μm, and, coated thereon, a solid porous resin coating having a filler dispersed therein, wherein the filler is selected from carbon fibres, carbon particles and mixtures thereof. The presence of carbon enhances the stiffness of the stencil master, and, above a certain minimum concentration, the presence of carbon fibre and or alternatively carbon pigment particles will confer an antistatic effect, as described above in relation to other aspects of the invention.

Typically, the carbon included in the porous resin coating is in the form of fibres, typically having a diameter of greater than 1 μm and less than 10 μm, and typically having a length in the range 100 μm to 14 mm, preferably 100 μm to 500 μm. The use of milled carbon fibres, generally having a length in the range 100 to 500 μm, may facilitate dispersion in the porous coating.

The heat-sensitive film is generally as described above in relation to the other aspects of the present invention. The porous resin coating may take the form of a solid foam coating, prepared by drying a liquid foam coating applied to a heat-sensitive film, as described above in relation to other aspects of the present invention, or the coating may be formed according to any of the known prior art methods, for instance as disclosed in GB 2306689, GB 2336916 and GB 2350691. The porous resin coating may comprise any of the resinous materials described above in relation to the other aspects of the present invention.

The stencil master according to this aspect of the present invention may also include any of the optional additives described above in relation to the other aspects of the present invention.

Furthermore, the stencil master may be thermally imaged to produce voids in the heat-sensitive polymeric film, thereby giving rise to a stencil which finds use in a digital duplicating printing process.

The present invention is further illustrated by the following Examples.

### EXAMPLES

### Examples 1A-1C

Heat-sensitive stencils incorporating solid foam coatings as a porous layer were made by the following method:

### Preparation of Liquid Foam

The following components were added to a 500 ml glass beaker:

| | | |
|---|---|---|
| i) | Water | 33.7 g |
| ii) | 10% solution hydroxypropylcellulose | 8.6 g |
| | (Klucel E, Industrial Grade, Hercules Inc) | |
| | in water | |
| iii) | 50% styrene acrylate resin emulsion | 51.4 g |
| | (Revacryl 385, Synthomer Ltd) | |
| iv) | 25% solution ammonium stearate in water | 6.3 g |

The combined components were then stirred for 1 minute using a Heidolph Model RGL 500 stirrer using a 50 mm stirrer blade to generate a liquid foam. The foam volume was then measured from its height in the beaker and its viscosity measured by a Brookfield Model DV1+ viscometer at rotation speed 100, using a No.4 spindle.

### Preparation of Solid Foam Coatings

The liquid foam was coated on to a high shrink polyester film, thickness 2.0 μm, of type used to manufacture conventional heat-sensitive digital stencils, using a wire wound Mayer bar to control the coating thickness. Bars with the following wire diameters were used.

| Example | Mayer Bar Wire Diameter (inches) |
|---|---|
| 1A | 0.070 |
| 1B | 0.075 |
| 1C | 0.150 |

The coatings were dried in an oven at a temperature of 60° C. for 5 minutes. The resultant solid foam coated film was then measured to determine coating weight, coating thickness, stiffness (using a Lorentzen and Wettre Stiffness Tester Model SE016 under the following conditions: sample width 38 mm, bending angle 30°, bending length 1 mm, bending speed 5°/s, temperature 22±2° C., relative humidity 65±10%) and tensile strength (using a Testometric Micro 350 (fitted with flat face rubber grips) under the following conditions: gauge length 180 mm, gauge width 15 mm, speed 100 mm/min, temperature 22±2° C., relative humidity 65±10%).

A thin silicone coating was applied to the film surface opposite the solid foam and dried. The resultant stencil masters were then imaged and printed on a Gestetner CopyPrinter Model 5380 digital duplicator. The stencils all gave good image density (measured using a Macbeth RD914 densitometer) and even ink coverage.

The results for Examples 1A-C are summarised in Table 1, below.

### Examples 2A-2G

### Preparation of Liquid Foam

The method described for Example 1 was used except that for examples 2A-2G alternative resin emulsions were used as below:

| Example | Resin Emulsion | Amount |
|---|---|---|
| 2A | 35% fully reacted polyurethane | 81.9 g |
| | (Ucecoat DW7770, UCB Ltd) | |
| 2B | 40% acrylate/methacrylate copolymer | 64.2 g |
| | (NeoCryl BT-20, NeoResins) | |
| 2C, F, G | 50% styrene/acrylate copolymer | 51.2 g |
| | (Revacryl 385, Synthomer Ltd) | |
| 2D | 50% styrene/acrylate copolymer | 57.4 g |
| | (Revacryl 385, Synthomer Ltd) | |
| 2E | 42% styrene/acrylonitrile copolymer | 68.3 g |
| | (Revacryl 826, Synthomer Ltd) | |

For all the above examples the amount of water was adjusted to give a total combined weight of 85.1 g.

The weights of hydroxypropyl cellulose and ammonium stearate solutions were the same as Example 1.

### Preparation of Solid Foam Coatings

The method described for Example 1 was used with Mayer bar wire diameters as indicated below. The gap-wound bars used in this and later examples were manufactured by RK Print Coat Instruments Ltd (UK).

| Example | Mayer Bar Wire Diameter (inches) |
|---|---|
| 2A | 0.050 |
| 2B, 2C | 0.064 |
| 2D, 2E, 2F | 0.075 |
| 2G | 0.150 |
| | (gap wound) |

The Mayer bar wire diameter was selected so that approximately the same weight of coating was achieved for each example (12.55-12.99 g/m²). The results, summarised in Table 2 below, indicate that for an equivalent coating weight stiffness relates to coating density regardless of polymer type.

### Example 3

The liquid foam was the same as that used in Example 1. The solid foam was prepared by exactly the same process as in Example 1 using gap-wound Mayer bars with wire diameters as indicated below:

| Example | Mayer Bar Wire Diameter (inches) |
|---|---|
| 3A | 0.150 |
| 3B | 0.200 |
| 3C | 0.300 |

The results obtained are summarised in Table 3, below. The stiffness of the coatings increases with coating weight.

### Example 4

This example is analogous to Example 3 with the incorporation of carbon fibre.

### Preparation of Liquid Foam

The following components were combined to foam the liquid phase.

| | | |
|---|---|---|
| i) | Water | 31.1 g |
| ii) | 10% solution hydroxypropylcellulose | 8.6 g |
| | (Klucel E, Industrial Grade, Hercules Inc) | |
| iii) | 50% styrene acrylate resin emulsion | 51.4 g |
| | (Revacryl 385, Synthomer Ltd) | |
| iv) | Carbon fibre (3 mm length, diameter | 2.6 g |
| | 7 microns) | |
| v) | 25% ammonium stearate solution | 6.3 g |

The liquid foam was prepared in the same manner as Example 3 to achieve an identical foam volume.

### Preparation of Solid Foam Coatings

Solid foams were prepared by the same method as Example 3 using gap-wound Mayer bars with wire diameters indicated below:

| Example | Mayer Bar Wire Diameter (inches) |
|---|---|
| 4A | 0.150 |
| 4B | 0.300 |
| 4C | 0.400 |

The results for Example 4 are summarised in Table 3, below. The effect of adding carbon fibre is to achieve significant increases in both stiffness and tensile strength compared with equivalent coatings where the carbon fibre is absent. Tensile strength increased with increasing coating weight when carbon fibre is incorporated, unlike the comparative coatings.

### Example 5

The liquid foam was the same as that used in Example 1. The solid foam was prepared by exactly the same process as in Example 1 using a Mayer bar with a wire diameter of 0.200 inches.

The results for this example are summarised in Table 4, below.

### Examples 6A and 6B

### Preparation of Liquid Foam

The following components were added to a 500 ml glass beaker:

| | |
|---|---|
| Water | 1.0 g |
| 10% solution hydroxypropylcellulose | 8.6 g |
| (Klucel E, Industrial Grade, Hercules Ltd) | |
| 35% radiation curable polyurethane emulsion | 77.8 g |
| (Ucecoat DW 7849, UCB Ltd) | |
| 25% ammonium stearate solution in water | 12.6 g |

The liquid foam was prepared as Example 1 except that the components were stirred for a period of two minutes.

### Preparation of Solid Foam Coating

Solid foam coatings were prepared by the method of Example 1 using a Mayer bar with a wire diameter of 0.075 inches. After drying, Example 6B was irradiated by an electron beam source providing a dose of 4 MRad at 200 kVolts acceleration voltage.

The results for these examples are summarised in Table 4, below. Example 6A is of comparable coating weight to Example 5 but has higher density and significantly lower stiffness. Sample 6B which was subjected to EB irradiation demonstrates a significant increase in both stiffness and tensile strength in comparison with both Example 5 and Example 6A.

### Example 7

### Preparation of Liquid Foam

Liquid foams were prepared from the formulations below using the method described in Example 1.

| Component | Example 7A | Example 7B | Example 7C |
|---|---|---|---|
| Water | 42.3 g | 41.9 g | 41.5 g |
| 5.0% styrene | 51.4 g | 51.4 g | 51.4 g |
| acrylate resin | | | |
| emulsion | | | |
| (Revacryl | | | |
| 385 Synthomer | | | |
| Ltd) | | | |
| 25% ammonium | 6.3 g | 6.3 g | 6.3 g |
| stearate in | | | |
| water | | | |
| Milled carbon | 0.0 g | 0.4 g | 0.8 g |
| fibre: 0.18 mm × 7.5 μm | | | |

### Preparation of Solid Foam

Solid foam coatings were prepared by the method of Example 1 using a Mayer bar with a wire diameter of 0.064 inches. After drying, the foam coatings were subjected to electron beam irradiation at a dose of 3 Mrad, 125 kVolts acceleration voltage.

The results for this Example are given in Table 5, below, where it is evident that the inclusion of higher amounts of milled carbon fibre enhances the stiffness of the solid foam coating. It can also be seen that the addition of carbon fibre confers antistatic properties to the solid foam and that electrical conductivity is increased at an increased concentration of carbon fibre.

### Example 8

### Preparation of Liquid Foam

Liquid foams were prepared from the formulations below using the method described in Example 1.

| Component | Example 8A | Example 8B | Example 8C |
|---|---|---|---|
| Water | 15.9 g | 14.9 g | 13.9 g |
| 35% radiation | 77.8 g | 77.8 g | 77.8 g |
| curable | | | |
| polyurethane | | | |
| emulsion | | | |
| (Ucecoat | | | |
| DW7 770, | | | |
| UCB Ltd) | | | |
| 29% sodium | 0.0 g | 1.0 g | 2.0 g |
| lauryl | | | |
| sulphate in | | | |
| water (Neopon | | | |
| LS/NF, Akzo | | | |
| Nobel) | | | |
| 25% | 6.3 g | 6.3 g | 6.3 g |
| ammonium | | | |
| stearate | | | |

### Preparation of Solid Foam

Solid foam coatings were prepared by the method of Example 1 using a Mayer bar with a wire diameter of 0.040 inches. After drying, the foam coatings were subjected to electron beam irradiation with a dose of 3 Mrad at 125 kVolts acceleration voltage.

The results for this Example are summarized in Table 6, below. Coating 8A, which does not contain a sulphate foaming agent, is not antistatic having a surface electrical resistance of 10¹⁴ ohms/square. Coating 8B containing 0.29% sodium lauryl sulphate is marginally antistatic, and coating 8C containing 0.58% sodium lauryl sulphate has good antistatic properties with a surface electrical resistance of less than 10¹¹ ohms/square.

### Example 9

### Preparation of Liquid Foam

Liquid foams using the formulation provided in Example 1 were prepared as follows:

Example 9—method as described in Example 1.

Example 9A—prepared using an Aphron generator of the type described above where the rotating disc had a diameter of 65 mm. The rotation speed at commencement of foam generation was 7000 rpm.

### Preparation of Solid Foam

Solid foam coatings were prepared and dried by the method described in Example 1B, using a Mayer bar with a wire diameter of 0.003 inches.

The results for this Example are given in Table 7, below. The term “incomplete coating” means that a large portion of the heat-sensitive film base remained exposed after carrying out the coating process, as a result of oversize bubbles generated by a conventional foam generator.

TABLE 1

| PARAMETERS | DETAILS | MEASURES | | |
|---|---|---|---|---|
| | | Example 1 | | |
| Liquid Phase component | | | | |
| Water | | 33.7 | | |
| 10% Klucel 99-E solution | Hydroxypropylcellulose | 8.6 | | |
| Revacryl 385 | Styrene/acrylate emulsion (50% solids) | 51.4 | | |
| 25% ammonium stearate solution | | 6.3 | | |
| TOTAL | | 100 | | |
| Coating Foam | | | | |
| Air:liquid ratio | Foam volume/liquid volume | 3.8 | | |
| Viscosity (cP) | Brookfield spindle 4, speed 100 | 2000 | | |
| | | 1A | 1B | 1C |
| Solid Foam coating | | | | |
| Mayer bar wire | Wire diameter (inches) × 1000 | 70 | 75 | 150 |
| Coating Weight | g/m2 | 7.25 | 8.25 | 10.85 |
| Thickness | μm | 55.4 | 65.8 | 91.0 |
| Density | g/cm3 | 0.131 | 0.125 | 0.113 |
| Stiffness | mN | 16 | 33 | 45 |
| Tensile strength | kgF | 0.29 | 0.31 | 0.31 |
| Printing Quality | | | | |
| Image density | Macbeth RD 914 densitometer | 1.00 | 0.99 | 1.02 |

TABLE 2

| | | MEASURES | | | | | | |
|---|---|---|---|---|---|---|---|---|
| | | Examples | | | | | | |
| PARAMETERS | DETAILS | 2A | 2B | 2C | 2D | 2E | 2F | 2G |
| Liquid Phase component | | | | | | | | |
| Water | | 3.2 | 13.4 | 33.9 | 27.7 | 16.8 | 33.9 | 33.9 |
| 10% Klucel 99-E solution | Hydroxypropylcellulose | 8.6 | 8.6 | 8.6 | 8.6 | 8.6 | 8.6 | 8.6 |
| Ucecoat DW7770 | Fully reacted polyurethane (35% solids) | 81.9 | — | — | — | — | — | — |
| Neocryl BT-20 | Acrylate copolymer (40% solids) | — | 71.7 | — | — | — | — | — |
| Revacryl 385 | Styrene acrylate (50% solids) | — | — | 51.2 | — | — | — | — |
| Revacryl 385 | Styrene acrylate (50% solids) | — | — | — | 57.4 | — | — | — |
| Revacryl 826 | Acrylate/acrylonitrile (42% solids) | — | — | — | — | 68.3 | — | — |
| Revacryl 385 | Styrene acrylate (50% solids) | — | — | — | — | — | 51.2 | — |
| Revacryl 385 | Styrene acrylate (50% solids) | — | — | — | — | — | — | 51.2 |
| 25% ammonium | | 6.3 | 6.3 | 6.3 | 6.3 | 6.3 | 6.3 | 6.3 |
| stearate solution | | | | | | | | |
| TOTAL | | 100 | 100 | 100 | 100 | 100 | 100 | 100 |
| Coating Foam | | | | | | | | |
| Air:liquid ratio | Foam volume/liquid volume | 2.0 | 2.5 | 2.0 | 3.3 | 3.0 | 2.0 | 3.5 |
| Viscosity (cP) | Brookfield spindle 4, speed 100 | 1240 | 2076 | — | 1242 | 1950 | — | 1536 |
| Solid Foam coating | | | | | | | | |
| Mayer bar wire | Wire diameter (inches) × 1000 | 50 | 64 | 64 | 75 | 75 | 75 | 150 |
| Coating Weight | g/m2 | 12.57 | 12.97 | 12.70 | 12.99 | 12.55 | 12.55 | 12.67 |
| Thickness | μm | 30.8 | 51 | 51.0 | 52.4 | 60.6 | 70.4 | 110.4 |
| Density | g/cm3 | 0.408 | 0.254 | 0.249 | 0.248 | 0.207 | 0.178 | 0.115 |
| Stiffness | mN | 13 | 26 | 28 | 27 | 32 | 38 | 46 |
| Tensile strength | kgF | 0.35 | 0.36 | 0.35 | 0.34 | 0.37 | 0.33 | 0.32 |

TABLE 3

| PARAMETERS | DETAILS | MEASURES | | | | | |
|---|---|---|---|---|---|---|---|
| | | Examples | | | | | |
| | | 3 | | | 4 | | |
| Liquid Phase component | | | | | | | |
| Water | | 33.7 | | | 31.1 | | |
| 10% Klucel 99-E solution | Hydroxypropylcellulose | 8.6 | | | 8.6 | | |
| Revacryl 385 | Styrene/acrylate emulsion | 51.4 | | | 51.4 | | |
| | (50% solids) | | | | | | |
| Carbon fibre | | — | | | 2.6 | | |
| 25% ammonium | | 6.3 | | | 6.3 | | |
| stearate solution | | | | | | | |
| TOTAL | | 100 | | | 100 | | |
| Coating Foam | | | | | | | |
| Air:liquid ratio | Foam volume/liquid volume | 3.5 | | | 3.5 | | |
| Viscosity (cP) | Brookfield spindle 4, speed 100 | 1536 | | | 2718 | | |
| Solid Foam coating | | 3A | 3B | 3C | 4A | 4B | 4C |
| Mayer bar wire | Wire diameter (inches) × 1000 | 150 | 200 | 300 | 150 | 300 | 400 |
| Coating Weight | g/m2 | 12.67 | 17.82 | 23.43 | 12.73 | 19.49 | 23.97 |
| Thickness | μm | 110.4 | 159.8 | 175.4 | 101.6 | 148.8 | 206.8 |
| Density | g/cm3 | 0.115 | 0.112 | 0.134 | 0.125 | 0.131 | 0.116 |
| Stiffness | mN | 46 | 109 | 165 | 105 | 278 | 415 |
| Tensile strength | kgF | 0.3264 | 0.3544 | 0.3527 | 0.4363 | 0.7556 | 0.8912 |

TABLE 4

| PARAMETERS | DETAILS | MEASURES | | |
|---|---|---|---|---|
| | | Examples | | |
| | | 5 | 6 | |
| Liquid Phase component | | | | |
| Water | | 33.7 | 1.0 | |
| 10% Klcel 99-E solution | Hydroxypropylcellulose | 8.6 | 8.6 | |
| Revacryl 385 | Styrene/acrylate | 51.4 | — | |
| Ucecoat DW 7849 | Radiation-curable polyurethane | — | 77.8 | |
| 25% ammonium stearate solution | | 6.3 | 12.6 | |
| TOTAL | | 100 | 100.0 | |
| Coating Foam | | | | |
| Air:liquid ratio | Foam volume/liquid volume volume | 3.8 | 2.2 | |
| Viscosity (cP) | Brookfield spindle 4, speed 100 | 2022 | 2280 | |
| EB Curing | | | | |
| Dose | Mrad | — | — | 4 |
| Acceleration voltage | kVolts | — | — | 200 |
| | | 5 | 6A | 6B |
| Solid Foam coating | | | | |
| Mayer bar wire | Wire diameter (inches) × 1000 | 200 | 75 | 75 |
| Coating Weight | g/m2 | 14.67 | 15.15 | 15.07 |
| Thickness | μm | 125.0 | 41.4 | 42.6 |
| Density | g/cm3 | 0.117 | 0.366 | 0.354 |
| Stiffness | mN | 75 | 15 | 120 |
| Tensile strength | kgF | 0.33 | 0.33 | 0.72 |

TABLE 5

| | | MEASURES | | |
|---|---|---|---|---|
| | | Example | | |
| | | 7A | 7B | 7C |
| PARAMETERS | DETAILS | parts by weight | | |
| Liquid phase component | | | | |
| Water | | 42.3 | 41.9 | 41.5 |
| Revacryl 385 | Styrene/acrylate emulsion (50% solids) | 51.4 | 51.4 | 51.4 |
| 25% ammonium stearate solution | | 6.3 | 6.3 | 6.3 |
| Milled carbon fibre | | 0.0 | 0.4 | 0.8 |
| TOTAL | | 100.0 | 100.0 | 100.0 |
| Liquid Foam | | | | |
| Air:liquid ratio | Foam volume/liquid volume | 2.7 | 2.7 | 2.7 |
| Solid Foam Coating | | | | |
| Mayer wire bar | Wire diameter (inches) × 1000 | 64 | 64 | 64 |
| Coating weight | g/m2 | 8.29 | 8.99 | 8.31 |
| Thickness | μm | 48.4 | 49.6 | 48.8 |
| Stiffness | mN | 18 | 20 | 22 |
| Density | g/cm3 | 0.171 | 0.181 | 0.170 |
| Surface electrical resistance (SER) | ohms/square | 3.96 × 10¹⁴ | 2.36 × 10¹² | <1 × 10¹¹ |

TABLE 6

| | | MEASURES | | |
|---|---|---|---|---|
| | | Example | | |
| | | 8A | 8B | 8C |
| PARAMETERS | DETAILS | parts by weight | | |
| Liquid phase component | | | | |
| Water | | 15.9 | 14.9 | 13.9 |
| Ucecoat DW7770 | Fully reacted polyurethane (35% solids) | 77.8 | 77.8 | 77.8 |
| Neopon LS/NF | Sodium lauryl sulphate (29% solids) | 0.0 | 1.0 | 2.0 |
| 25% ammonium stearate solution | | 6.3 | 6.3 | 6.3 |
| TOTAL | | 100.0 | 100.0 | 100.0 |
| Coating Foam | | | | |
| Air:liquid ratio | Foam volume/liquid volume | 2.4 | 2.7 | 2.9 |
| Solid Foam Coating | | | | |
| Mayer wire bar | Wire diameter (inches) × 1000 | 40 | 40 | 40 |
| Coating weight | g/m2 | 8.11 | 6.85 | 6.41 |
| Thickness | μm | 25.6 | 19.8 | 13.2 |
| Density | g/cm3 | 0.317 | 0.346 | 0.486 |
| Surface electrical resistance (SER) | ohms/square | 5.8 × 10¹⁴ | 4.28 × 10¹³ | <1 × 10¹¹ |

TABLE 7

| | | MEASURES | |
|---|---|---|---|
| | | Example 9 | Example 9A |
| PARAMETERS | DETAILS | parts by weight | parts by weight |
| Liquid phase component | | | |
| Water | | 33.7 | 33.7 |
| 10% Klucel 99-E solution | Hydroxypropylcellulose | 8.6 | 8.6 |
| Revacryl 385 | Styrene/acrylate emulsion (50% solids) | 51.4 | 51.4 |
| 25% ammonium stearate solution | | 6.3 | 6.3 |
| TOTAL | | 100.0 | 100.0 |
| Liquid Foam | | | |
| Mixing method | | 50 mm blade | Aphron generator |
| Air:liquid ratio | Foam volume/liquid volume | 2.7 | 2.7 |
| Maximum bubble size | microns | 100 | 50 |
| Solid Foam Coating | | | |
| Mayer wire bar | Wire diameter (inches) × 1000 | 30 | 30 |
| Coating uniformity | | incomplete coating | complete coating |
| Coating weight | g/m2 | — | 5.65 |
| Thickness | μm | — | 24.8 |
| Stiffness | mN | — | 5 |
| Density | g/cm3 | — | 0.228 |
| Solids | % | — | 27.1 |
| Liquid coat weight | g/m2 | — | 20.82 |
| Liquid foam density | g/cc | — | 0.321 |
| Wet film thickness | μm | — | 64.9 |

1-27. (canceled)

28. A method for manufacturing a heat-sensitive stencil comprising coating onto a heat-sensitive polymeric film having a thickness of less than 10 μm, a liquid foam comprising a resin dispersed or dissolved in a volatile liquid, and a foaming agent; drying the liquid foam to form a solid foam coating; and cross-linking the solid foam coating by exposure to radiation.

29. A method according to claim 28, wherein the volatile liquid is water.

30. A heat-sensitive stencil master produced by the method defined in claim 28.

31. A method according to claim 28, wherein said radiation is by exposure to electron beams.

32. A method according to claim 29, wherein said radiation is by exposure to electron beams.

33. A method according to claim 28, wherein the foaming agent is a surfactant having an HLB of greater than 6.

34. A method according to claim 28, wherein the solid foam coating incorporates a fibrous material.

35. A method according to claim 34, wherein the fibrous material has a diameter of greater than 1 μm and less than 10 μm, and a length in the range of 100 μm to 14 mm.

36. A method according to claim 35, wherein the fibrous material has a length in the range of 100 μm to 500 μm.

37. A method according to claim 34, wherein the fibrous material is selected from the group consisting of carbon fibres, glass fibres, polymeric fibres, and mixtures thereof.

38. A method according to claim 37, wherein the fibrous material includes polymeric fibres selected from the group consisting of polyester fibres, polyvinyl alcohol fibres, and mixtures thereof.

39. A method according to claim 37, wherein the fibrous material comprises carbon fibres.

40. A method according to claim 28, wherein the solid foam comprises a thermoplastic resin.

41. A method according to claim 28, wherein the solid foam coating incorporates an antistatic agent.

42. A method according to claim 28, wherein the heat-sensitive polymeric film has a release coating on the side of the film opposite the solid foam coating.

43. A method according to claim 28, wherein the foaming agent comprises ammonium stearate, a sulphate foaming agent, or a mixture thereof.

44. A stencil for use in a digital printing process comprising the heat-sensitive stencil master according to claim 30, which has been thermally imaged to produce voids in the heat-sensitive polymeric film.

45. A digital duplicating printing process comprising using the heat-sensitive stencil master according to claim 30.

46. A digital duplicating process comprising using the stencil according to claim 44.
